(19) United States
(12) Patent Application Publication
(10) Pub. No.: US 2020/0097025 A1
(43) Pub. Date: Mar. 26, 2020

(54) AN UAV FIXED POINT HOVER SYSTEM AND METHOD

(71) Applicant: BEIJING UNIVERSITY OF TECHNOLOGY, BEIJING (CN)

(72) Inventors: WENLI ZHANG, BEIJING (CN); YINGXUAN MA, BEIJING (CN); HAO FENG, BEIJING (CN); XIANG GUO, BEIJING (CN)

(21) Appl. No.: 16/495,089

(22) PCT Filed: Dec. 5, 2017
(86) PCT No.: PCT/CN2017/114574

§ 371 Date: Sep. 17, 2019

(30) Foreign Application Priority Data
Nov. 15, 2017 (CN) 201711133073.8

(51) Int. Cl. G05D 1/08; B64C 39/02; G05D 1/00; G06T 7/40; G06T 7/246; G06T 7/73; G06T 7/11

(52) U.S. Cl. CPC G05D 1/0816; B64C 39/024; G05D 1/0088; G06T 7/40; G06T 7/246; G06T 2207/20021; G06T 7/11; B64C 2201/141; G06T 2207/10016; G06T 2207/10032; G06T 7/73

(57) ABSTRACT

The invention relates to the field of unmanned aerial vehicle (UAV), and especially relates to a UAV fixed point hover system and method which can be used in indoor environment. The system comprising UAV UAV flight controller, fixed point hover control module and UAV motor module. UAV flight controller is used to control the flight of UAV; fixed point hover control module is used to control fixed point hover in UAV flight; motor module is used to change the flight motion state of UAV. The system provided by the invention includes a UAV system and method for UAV flight control, motor and fixed point hover control module. In fixed point hover control module, texture features are used to obtain effective areas, compared with the traditional fixed-point optical flow method, the computation is reduced. Then optical flow field is calculated by using optical flow method for above effective areas, to obtain the information of control acceleration.

### TECHNICAL FIELD

The invention relates to the field of unmanned aerial vehicle (UAV), and especially relates to a UAV fixed point hover system and method which can be used in indoor environment.

### BACKGROUND ART

With the development of economy and the continuous progress of science and technology, the research on UAV is getting deeper and deeper, it is widely used in aerial photography, mobile detection and security. The stability, accuracy and fast hovering ability of UAV flight platform have a very important influence on these fields.

UAV fixed point hover is defined as: through the autonomous flight function or the remote control device of the UAV to control the UAV stay in the designated position in the air for a certain time.

At present, the most mature and widely used method of UAV fixed point hover is GPS +barometer+gyroscope Integrated navigation system. The barometer is used to measure the height change, and the GPS module gives the coordinates of the horizontal position. Finally, the three-dimensional coordinates are obtained by combining the measurement data of the gyroscope, and the coordinates are provided to the UAV to realize fixed point hover.

However, due to the low refresh frequency of low-cost GPS data, the data provided by it will cause serious lag of attitude compensation command of the airframe in the narrow space or when the UAV moves at high speed which lead to serious consequences such as plane crash. Due to the shielding of GPS signals from buildings, the indoor GPS is in standby state, and the hover signal of UAV is completely controlled by inertial navigation device. However, after a long flight, the inertial navigation system will produce a large system error. The longer the flight time, the larger the error will be, and the accuracy rate of fixed point hover will decrease greatly.

In addition, there is a method to achieve fixed point hover of UAV through radio combined with laser technology. This technology firstly makes rough positioning of UAV through radio technology, and then makes position correction through laser technology to obtain the accurate position of fixed point hover. This method is more accurate than GPS fixed point method, but it is expensive and requires a lot of base station and laser emission equipment to be deployed in advance, so the popularity of this technology is not high.

Moreover, there is an optical flow fixed point method, which uses the airborne optical flow sensor to calculate the optical flow field of the UAV relative to the ground, so as to obtain the current velocity vector information of the UAV (velocity and direction), optical flow module calculates the inverse acceleration control variable to keep the UAV hovering at fixed point according to the above velocity vector information. This method does not need the assistance of external transmitting signal, so it has a wide range of application and a small system error, but it needs to calculate the light flow information of the whole image, the calculation amount is too large for the UAV's onboard processor to bear which will lower the calculation efficiency, and the control signal will be seriously delayed. Any small delay in flight can lead to serious consequences, so the practicability of this method needs to be improved.

There are two representative technologies available:

(1) Indoor positioning device (CN201620160519.0): an indoor positioning device, located on a UAV, comprising: ultrasonic emitting PCB board, ultrasonic receiving PCB board and optical flow PCB board, optical flow PCB board includes optical flow camera and microcontrol unit MCU, ultrasonic transmitter: generate and emit ultrasonic wave under the control of MCU on optical flow PCB; ultrasonic receiving board: sending ultrasonic wave to MCU on optical flow PCB board when receiving ultrasonic wave; optical flow camera: take images of the ground and transmit them to the MCU; MCU: control the ultrasonic emission of PCB board and start the timing. When the ultrasonic wave is received stop the timing and calculate the height of the UAV according to the time; The displacement of the UAV in the horizontal x direction and the vertical y direction on the ground is calculated according to the ground image from the optical flow camera. This device has too many components and high manufacturing cost. By attaching computers and a large number of auxiliary parts to improve the timeliness of optical flow positioning, the cost is too high and the problem of excessive calculation of optical flow algorithm cannot be solved.

(2) An UAV speed monitoring method and system (CN201610529291.2): an UAV speed monitoring method and system comprising: obtain the current flight altitude, angular velocity and image; obtain the feature points of the image and calculate the light flow of each feature point; count the optical flow of each feature point, select the optical flow with the highest repetition rate in the same direction as the optical flow of the image; Calculate the current flight speed according to the flight altitude, angular velocity and the light flow of the image. The invention also relates to a system corresponding to its UAV speed monitoring method. The optical flow of each feature point is calculated by obtaining the feature points of the current image through calculation, and the optical flow with the highest repetition rate of optical flow in the same direction is selected as the optical flow of the image. Then, the current flight speed is calculated according to the current flight height and angular velocity of the optical flow of the image. The calculation is simple, the computational amount is small, and the influence of multiple factors is taken into account, so the calculation result is accurate.

This invention effectively reduces the amount of light flow calculation. As a detection method, it fails to organically combine with the whole UAV to control the UAV's movement and attitude, so it cannot be effectively applied to the fixed point hovering of the UAV.

In view of the problems existing in the existing technology, this invention proposes an improved fixed point hovering method of UAV based on optical flow method. This invention is applicable to the fixed point hovering method without GPS signal, which can work normally without pre-deployed auxiliary equipment with a small amount of calculation. The fixed point accuracy and control signal refresh speed of this invention are superior to other existing methods within the applicable scope, it provides a technical basis for indoor application development of UAV.

### SUMMARY

The technical problem to be solved by the invention is: When optical flow method is used to calculate the optical flow field in the image, only the areas with obvious texture features can get the effective optical flow field, while the areas without obvious texture features cannot get the effective optical flow field. Traditional light flow fixed point method does not consider the texture feature, but calculates the light flow of the entire image, so the calculation amount is large, which affects the timeliness.

The invention adopts the following technical scheme to realize the intended purpose of invention: an UAV fixed point hover system, comprising UAV flight controller 10, fixed point hover control module 20 and UAV motor module 30.

UAV flight controller 10 is used to control the flight of UAV; fixed point hover control module 20 is used to control fixed point hover in UAV flight; motor module 30 is used to change the flight motion state of UAV.

UAV flight controller 10 includes data receiving module 110, control quantity calculation module 120 and electronic speed control module 130.

Data receiving module 110 is used to receive acceleration control variables sent by fixed point hover control module 20 and send them to control quantity calculation module 120; the control quantity calculation module 120 receives the control acceleration signal from the data receiving module 110, calculates the PWM waveform parameters needed to be generated according to the received control acceleration data, and then sends them to the electronic speed control module 130; electronic speed control module 130 generate PWM signals according to the information received from the control module 120.

Fixed point hover control module 20 includes image acquisition module 210, fixed point hover effective area identification module 220, optical flow field calculation module 230, control parameter calculation module 240 and data encoding-transmission module 250.

Image acquisition module 210 includes image sensor for video data collection and storage module for video data collection, fixed point hover effective area identification module 220 is a set of microcontrollers or microcomputer and drive structure, it uses SAD (Sum of absolute differences) algorithm to detect the identified texture areas in the image according to the image data collected by image acquisition module 210, and these areas are sent to optical flow field calculation module 230 as effective hovering areas; optical flow field calculation module 230 is a set of combined attitude sensors which is microcontroller and drive structure of gyroscope, segment video is obtained from the fixed point hovering effective area identification module 220, and the optical flow calculation is carried out by using HS (Horn-Schunck) optical flow method accompanied with compensation made according to motion state data provided by attitude sensor, finally, the velocity vector information of UAV relative to the ground is obtained and sent to the control parameter calculation module 240; according to the velocity vector data obtained by optical flow field calculation module 230, the control acceleration needed to maintain the UAV fixed point hover is calculated by control parameter calculation module 240 and sent to data encoding-transmission module 250; the function of data encoding-transmission module 250 is to encode and transmit the operation results to the data receiving module 110 in UAV flight controller 10.

An UAV fixed point hover method, the specific steps of fixed point hover control module 20 is as follows, the flow diagram is shown in FIG. 2.

S1: corresponding to image acquisition module 210, video information of fixed point hover position is obtained by image sensor in image acquisition module 210.

S2: corresponding to the fixed point hover effective area identification module 220, the detection and segmentation of texture area are carried out by fixed point hover effective area identification module 220, and effective fixed point hover area is finally identified. The specific operations are as follows:

S2.1: image portion

The M*N grayscale image collected by image acquisition module 210 is divided into sub-areas of n*n size, where M represents the length of grayscale image and N represents the width of grayscale image.

S2.2: calculation of the SAD

Calculate SAD value of each sub-areas divided in S2.1, the formula for calculating SAD value is as follows:

C=Σ₀^{M}Σ₀^{N}|fₜ₊₁−fₜ| (1)

fₜ represents the pixel value at current time t, fₜ₊₁ represents the pixel value at t+1, and C represents the SAD value.

C Is the sum of absolute value of the difference between two frames, namely SAD value, f represents the value of a pixel, t represents the current moment.

S2.3: determine the effective area of fixed point hover

SAD value of each area calculated in S2.2 is compared with the threshold value T, and the absolute value of difference 0 is the texture area which is consider as the effective area of fixed point hover. That is, if the absolute value of difference in this area is greater than 0, it is an effective area, and optical flow calculation is conducted.

S3: corresponding to fixed point hovering optical flow field calculation module 230

Using HS optical flow method or other optical flow algorithms to obtain the optical flow value by optical flow calculation for the effective area of fixed point hover divided from S2.2. The optical flow velocity is converted into metric velocity Vₜ through the similar triangular relation between the sensor and the actual object plane.

S4: corresponding to the parameter control module 240, the reverse acceleration of UAV fixed point is calculated according to the actual velocity Vₜ obtained in S3, and transmit it to UAV flight controller 10 to realize fixed point control.

Vₜ²=2ax (2)

wherein, “a” represents reverse acceleration and “x” represents the distance from the location point in the last cycle.

S5: corresponding to data encoding-transmission module 250, data “a” obtained in S4 is sent to flight control data receiving module 110 through 12C port;

S6: data receiving module 110 of UAV flight controller 10 receives UAV offset data “a” and transmits it to the control quantity calculation module 120;

S7: control quantity calculation module 120 receives data a and performs calculation to obtain the compensation amount of UAV movement offset which is UAV deviates from the velocity vector to the opposite velocity vector, then it is converted into electrical control signal and sent to electronic speed control module 130;

S8: electronic speed control module 130 receives the electrical regulation control signal sent by the control quantity calculation module 120, and controls the current output to the UAV motor module 30;

S9: UAV motor module 30 receives the current of the electronic speed control module 130, controls the UAV to move in the opposite direction of the existing movement, and makes UAV hover at fixed point.

The system provided by the invention includes a UAV system and method for UAV flight control, motor and fixed point hover control module. In fixed point hover control module, texture features are used to obtain effective areas, compared with the traditional fixed point optical flow method, the computation is reduced. Then optical flow field is calculated by using optical flow method for above effective areas, to obtain the information of control acceleration.

Compared with the existing technology, the invention reduces the amount of calculation of fixed point of light flow, improves the effectiveness of calculation and improves the stability of fixed point hover.

### THE APPENDED DRAWINGS

FIG. 1 is the architecture diagram of a UAV fixed point system based on optical flow method in representative embodiment of this invention.

FIG. 2 is the flow chart of UAV fixed point hover control module.

FIG. 3 is the flow chart of HS optical flow method.

### PREFERRED EMBODIMENT

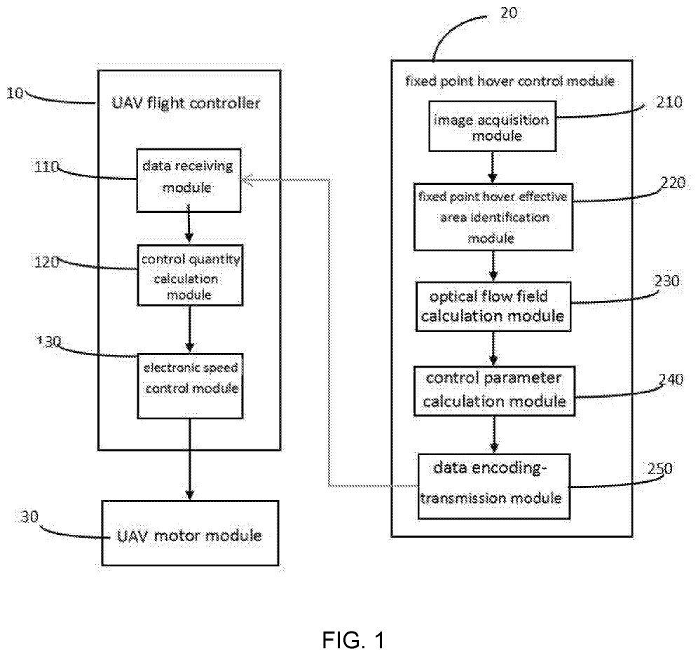

The embodiment of the invention is shown in FIG. 1 as a UAV fixed point hover system, including UAV flight controller 10, fixed point hover control module 20 and UAV motor module 30.

UAV flight controller 10 is used to control the flight of UAV; fixed point hover control module 20 is used to control fixed point hover in UAV flight; motor module 30 is used to change the flight motion state of UAV. UAV flight controller 10 includes data receiving module 110, control quantity calculation module 120 and electronic speed control module 130.

Data receiving module 110 is used to receive acceleration control variables sent by fixed point hover control module 20 and send them to control quantity calculation module 120; The control quantity calculation module 120 receives the control acceleration signal from the data receiving module 110, calculates the PWM waveform parameters needed to be generated according to the received control acceleration data, and then sends them to the electronic speed control module 130; electronic speed control module 130 generate PWM signals according to the information received from the control module 120.

Fixed point hover control module 20 includes image acquisition module 210, fixed point hover effective area identification module 220, optical flow field calculation module 230, control parameter calculation module 240 and data encoding-transmission module 250.

Image acquisition module 210 includes image sensor for video data collection and storage module for video data collection, fixed point hover effective area identification module 220 is a set of microcontrollers or microcomputer and drive structure, it uses SAD algorithm to detect the identified texture areas in the image according to the image data collected by image acquisition module 210, and these areas are sent to optical flow field calculation module 230 as effective hovering areas; optical flow field calculation module 230 is a set of combined attitude sensors which is microcontroller and drive structure of gyroscope, segment video is obtained from the fixed point hovering effective area identification module 220, and the optical flow calculation is carried out by using HS optical flow method accompanied with compensation made according to motion state data provided by attitude sensor, finally, the velocity vector information of UAV relative to the ground is obtained and sent to the control parameter calculation module 240; according to the velocity vector data obtained by optical flow field calculation module 230, the control acceleration needed to maintain the UAV fixed point hover is calculated by control parameter calculation module 240 and sent to data encoding-transmission module 250; the function of data encoding-transmission module 250 is to encode and transmit the operation results to the data receiving module 110 in UAV flight controller 10.

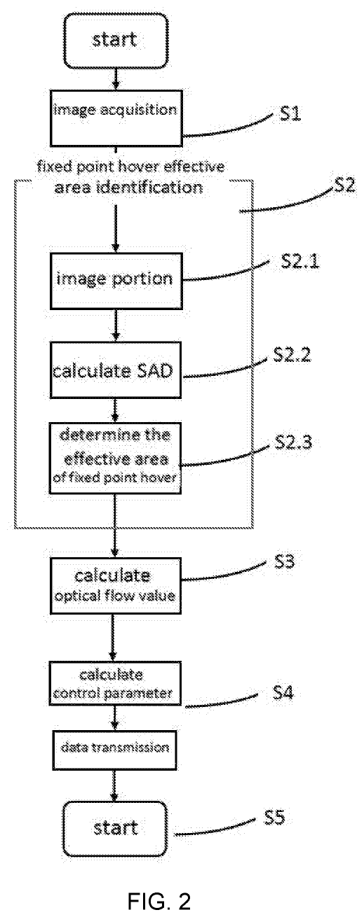

An UAV fixed point hover method, the specific s of fixed point hover control module 20 is as follows, the flow diagram is shown in FIG. 2.

S1: corresponding to image acquisition module 210, video information of fixed point hover position is obtained by image sensor in image acquisition module 210.

S2: corresponding to the fixed point hover effective area identification module 220, the detection and segmentation of texture area are carried out by fixed point hover effective area identification module 220, and effective fixed point hover area is finally identified. The specific operations are as follows:

S2.1: image portion

The M*N grayscale image collected by image acquisition module 210 is divided into sub-areas of n*n size, where M represents the length of grayscale image and N represents the width of grayscale image. In this embodiment, n=4.

S2.2: calculation of the SAD

Calculate SAD value of each sub-areas divided in S2.1, the formula for calculating SAD value is as follows:

C=Σ₀^{M}Σ₀^{N}|fₜ₊₁−fₜ| (1)

fₜ represents the pixel value at current time t, fₜ₊₁ represents the pixel value at t+1, and C represents the SAD value.

C Is the sum of absolute value of the difference between two frames, namely SAD value, f represents the value of a pixel, t represents the current moment.

S2.3: determine the effective area of fixed point hover

SAD value of each area calculated in S2.2 is compared with the threshold value T, and the absolute value of difference 0 is the texture area which is consider as the effective area of fixed point hover. That is, if the absolute value of difference in this area is greater than 0, it is an effective area, and optical flow calculation is conducted.

S3: corresponding to fixed point hovering optical flow field calculation module 230

Using HS optical flow method or other optical flow algorithms to obtain the optical flow value by optical flow calculation for the effective area of fixed point hover divided from S2.2. The optical flow velocity is converted into metric velocity Vₜ through the similar triangular relation between the sensor and the actual object plane.

S4: corresponding to the parameter control module 240, the reverse acceleration of UAV fixed point is calculated according to the actual velocity Vₜ obtained in S3, and transmit it to UAV flight controller 10 to realize fixed point control.

Vₜ²=2ax (2)

wherein, “a” represents reverse acceleration and “x” represents the distance from the location point in the last cycle.

S5: corresponding to data encoding-transmission module 250, data “a” obtained in S4 is sent to flight control data receiving module 110 through 12C port;

S6(or turn to attitude control): data receiving module 110 of UAV flight controller l0 receives UAV offset data “a” and transmits it to the control quantity calculation module 120;

S7: control quantity calculation module 120 receives data a and performs calculation to obtain the compensation amount of UAV movement offset which is UAV deviates from the velocity vector to the opposite velocity vector, then it is converted into electrical control signal and sent to electronic speed control module 130;

S8: electronic speed control module 130 receives the electrical regulation control signal sent by the control quantity calculation module 120, and controls the current output to the UAV motor module 30;

S9: UAV motor module 30 receives the current of the electronic speed control module 130, controls the UAV to move in the opposite direction of the existing movement, and makes UAV hover at fixed point.

The steps of HS optical flow method are as follows:

Two hypotheses are proposed:

1). The grayscale of a moving object remains constant at short intervals.

2). The velocity vector field changes slowly in a given neighborhood.

According to the above hypothesis, formula (3) can be obtained from equation (1):

I(x,y,t)=I(x+δx,y+δy,t+δt) (3)

Wherein, “I” represents optical flow value, “x” represents abscissa in grayscale image, “y” represents the ordinate in the grayscale image, and “t” represents current moment.

(x, y, t) Is the pixel point whose horizontal and vertical coordinates are (x,y) at time t of grayscale image.

proceed Taylor's expansion to the right-hand side of this equation at the point (x,y), when δt approaches 0 in the limit, the above formula can be expressed as:

$$\frac{\partial I}{\partial x} \frac{dx}{dt} + \frac{\partial I}{\partial v} \frac{dy}{dt} + \frac{\partial I}{\partial t} = 0 \qquad ( 4 )$$

Set u=dx/dt, v=dy/dt to obtain formula (5):

Iₓu+I_{y}v+Iₜ=0 (5)

Formula (5) is the optical flow constraint equation, which reflects a corresponding relationship between grayscale u and velocity v.

Iₓ represents the partial derivatives of I to X, I_{y} represents the partial derivatives of I to y, Iₜ represents the partial derivatives of I to t.

Formula (5) contains two variables: grayscale u and velocity v. Changes of u and v happens slowly as the pixels move, local area changes little, especially when the target does the rigid body without deformation, the rate of spatial change of the local area velocity is 0. Therefore, a new condition, the global smoothing constraint of optical flow, is introduced.

Therefore, the velocity smoothing term is introduced:

$${ζ}_{c}^{2} = {( \frac{\partial u}{\partial x} )}^{2} + {( \frac{\partial u}{\partial y} )}^{2} + {( \frac{\partial v}{\partial x} )}^{2} + {( \frac{\partial v}{\partial y} )}^{2} \qquad ( 6 )$$

For all pixel points (x,y,t), the sum of formula (6) needs to be minimized.

ζ represents velocity smoothing function, and ζc represents velocity smoothing function at the point of SAD value is c.

By integrating the optical flow constraint condition (3) and velocity smoothing constraint condition (4), the following minimization equation is established:

ζ²=∫∫α²ζ_{c}²+(Iₓu+I_{y}v+Iₜ)²dxdy (7)

The α in the formula is the smoothing weight coefficient, indicating that the greater the weight factor taken by the smooth term of velocity is, the higher the accuracy will be.

Adopting variational calculation, according to euler equation:

Iₓ²u+IₓI_{y}v=α²∇²u−IₓIₜ (8)

IₓI_{y}u+I_{y}²v=α²∇²v−I_{y}Iₜ (9)

Note: ∇ is the symbol of vector differential operator, and is the accepted mathematical symbol.

In formula (8) and (9), ∇ represents Laplace operator, approximated by the difference between the velocity at a certain point and the average velocity around it, has equations (10) and (11):

$$\begin{matrix}{u}^{n + 1} = {\overline{u}}^{n} - \frac{{I}_{x} ( {I}_{x} {\overline{u}}^{n} + {I}_{i} + {I}_{y} {\overline{v}}^{n} )}{λ + ( {I}_{x}^{2} + {I}_{y}^{2} )} & ( 10 ) \\ {v}^{n + 1} = {\overline{v}}^{n} - \frac{{I}_{y} ( {I}_{x} {\overline{u}}^{n} + {I}_{i} + {I}_{y} {\overline{v}}^{n} )}{λ + ( {I}_{x}^{2} + {I}_{y}^{2} )} & ( 11 )\end{matrix}$$

Iterative method is used to solve the problem. λ is the eigenvalue of the grayscale image pixel matrix.

The mean values of grayscale u and velocity v can be calculated using nine-point difference scheme.

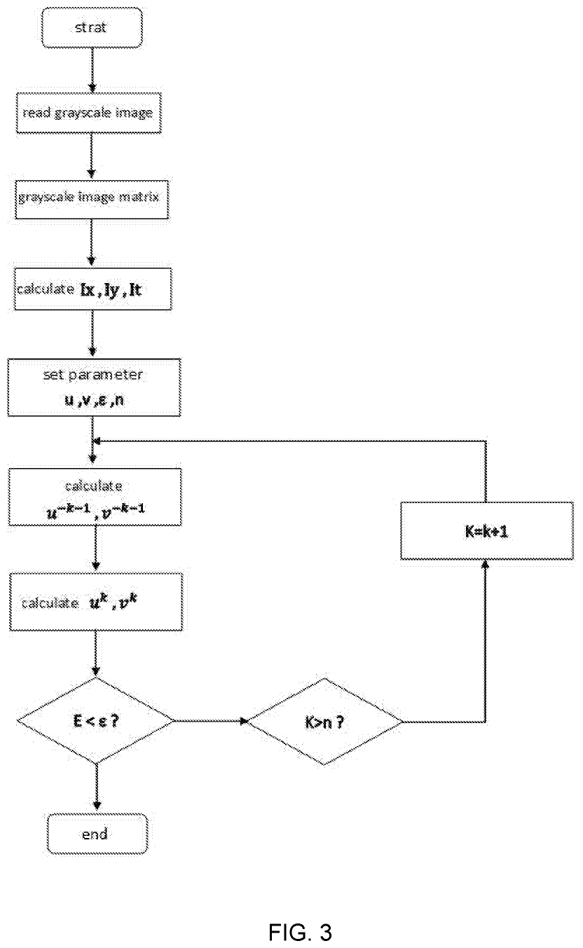

So far, all the quantities have been defined. The iterative operation of the grayscale of the two frames before and after input is carried out to obtain the velocity field. The specific execution process is shown in FIG. 3.

What is claimed is:

1. An UAV fixed point hover system, comprising UAV flight controller (10), fixed point hover control module (20) and UAV motor module (30);
UAV flight controller (10) is used to control the flight of UAV; fixed point hover control module (20) is used to control fixed point hover in UAV flight; motor module (30) is used to change the flight motion state of UAV;
UAV flight controller (10) includes data receiving module (110), control quantity calculation module (120) and electronic speed control module (130);
data receiving module (110) is used to receive acceleration control variables sent by fixed point hover control module (20) and send them to control quantity calculation module (120); the control quantity calculation module (120) receives the control acceleration signal from the data receiving module (110), calculates the PWM waveform parameters needed to be generated according to the received control acceleration data, and then sends them to the electronic speed control module (130); electronic speed control module (130) generate PWM signals according to the information received from the control module (120);
fixed point hover control module (20) includes image acquisition module (210), fixed point hover effective area identification module (220), optical flow field calculation module (230), control parameter calculation module (240) and data encoding-transmission module (250);
Image acquisition module (210) includes image sensor for video data collection and storage module for video data collection, fixed point hover effective area identification module (220) is a set of microcontrollers or microcomputer and drive structure, it uses SAD (Sum of absolute differences) algorithm to detect the identified texture areas in the image according to the image data collected by image acquisition module (210), and these areas are sent to optical flow field calculation module (230) as effective hovering areas; optical flow field calculation module (230) is a set of combined attitude sensors which is microcontroller and drive structure of gyroscope, segment video is obtained from the fixed-point hovering effective area identification module (220), and the optical flow calculation is carried out by using HS (Horn-Schunck) optical flow method accompanied with compensation made according to motion state data provided by attitude sensor, finally, the velocity vector information of UAV relative to the ground is obtained and sent to the control parameter calculation module (240); according to the velocity vector data obtained by optical flow field calculation module (230), the control acceleration needed to maintain the UAV fixed point hover is calculated by control parameter calculation module (240) and sent to data encoding-transmission module (250); the function of data encoding-transmission module (250) is to encode and transmit the operation results to the data receiving module (110) in UAV flight controller (10).

2. An UAV fixed point hover method by using UAV fixed point hover system in claim 1 comprising: the specific steps of fixed point hover control module (20) is as follows:
S1: corresponding to image acquisition module (210), video information of fixed point hover position is obtained by image sensor in image acquisition module (210);
S2: corresponding to the fixed point hover effective area identification module (220), the detection and segmentation of texture area are carried out by fixed point hover effective area identification module (220), and effective fixed point hover area is finally identified; the specific operations are as follows:
S2.1: image portion
M*N grayscale image collected by image acquisition module 210 is divided into sub-areas of n*n size, where M represents the length of grayscale image and N represents the width of grayscale image;
S2.2: calculation of the SAD
calculate SAD value of each sub-areas divided in S2.1, the formula for calculating SAD value is as follows:
C=Σ₀^{M}Σ₀^{N}|fₜ₊₁−fₜ| (1)
fₜ represents the pixel value at current time t, fₜ₊₁ represents the pixel value at t+1, and C represents the SAD value;
C Is the sum of absolute value of the difference between two frames, namely SAD value, f represents the value of a pixel, t represents the current moment;
S2.3: determine the effective area of fixed point hover
SAD value of each area calculated in S2.2 is compared with the threshold value T, and the absolute value of difference 0 is the texture area which is consider as the effective area of fixed point hover; that is, if the absolute value of difference in this area is greater than 0, it is an effective area, and optical flow calculation is conducted;
S3: corresponding to fixed point hovering optical flow field calculation module (230)
using HS optical flow method or other optical flow algorithms to obtain the optical flow value by optical flow calculation for the effective area of fixed point hover divided from S2.2;
the optical flow velocity is converted into metric velocity Vₜ through the similar triangular relation between the sensor and the actual object plane;
S4: corresponding to the parameter control module (240), the reverse acceleration of UAV fixed point is calculated according to the actual velocity Vₜ obtained in S3, and transmit it to flight control module 10 to realize fixed point control;
Vₜ²=2ax (2)
wherein, “a” represents reverse acceleration and “x” represents the distance from the location point in the last cycle;
S5: corresponding to data encoding-transmission module (250), data “a” obtained in S4 is sent to flight control data receiving module (110) through 12C port;
S6: data receiving module (110) of flight control module (10) receives UAV offset data “a” and transmits it to the control quantity calculation module (120);
S7: control quantity calculation module (120) receives data a and performs calculation to obtain the compensation amount of UAV movement offset which is UAV deviates from the velocity vector to the opposite velocity vector, then it is converted into electronic speed control signal and sent to electronic speed control module (130);
S8: electronic speed control module (130) receives the electrical regulation control signal sent by the control quantity calculation module (120), and controls the current output to the UAV motor module (30);
S9: UAV motor module (30) receives the current of the electronic speed control module (130), controls the UAV to move in the opposite direction of the existing movement, and makes UAV hover at fixed point.
